(19) United States
(12) Patent Application Publication
(10) Pub. No.: US 2002/0133473 A1
(43) Pub. Date: Sep. 19, 2002

(54) System and method for on-demand pricing for differentiated services computer networks

(75) Inventors: Marcus Bryan Grande, Pflugerville, TX (US); Michel Kouadio, College Station, TX (US)

Correspondence Address: Joseph T. Van Leeuwen, P.O. Box 81641, Austin, TX, 78708-1641, US

(73) Assignee: International Business Machines Corporation

(21) Appl. No.: 09/810,063

(22) Filed: Mar. 15, 2001

(51) Int. Cl. G06F 17/60; G06F 15/16; H04Q 11/00; H04L 12/16; H04L 12/28; G07B 15/02; G06F 17/00; G06F 15/173

(52) U.S. Cl. 705/418; 709/204; 370/351; 709/203; 370/260; 709/223

(57) ABSTRACT

A system and method providing prioritized service on a computer network such as the Internet is disclosed. A user requests a service upgrade from their Internet Service Provider (ISP). In response to the service upgrade request, the ISP marks request packets sent by the user as priority packets and also records the upgraded service in a billing database. When the user no longer needs upgraded service, he requests that normal service resume. During normal service, packets are marked as normal priority packets and the customer is billed at a normal, or flat, rate. Routers and other packet handling devices provide preferential handling of the packets marked as priority packets. When a router's queue is full, the router drops normal priority packets before dropping any higher priority packets. In addition, a queue manager can organize the router's queue so that high priority packets are processed before their normal priority counterparts.

### RELATED APPLICATIONS

This application is related to the following co-pending U.S. Patent Application filed on the same day and having the same inventors and assignee: “System and Method for Pricing Agent for Differentiated Services Computer Networks” (IBM Docket No. AUS9-2001-0103-US1), each by Grande and Kouadio, and each assigned to International Business Machines Corporation.

### BACKGROUND OF THE INVENTION

1. Technical Field

The present invention relates in general to a system and method for providing network usage pricing based on a user's service demands. More particularly, the present invention relates to a system and method for providing a means to track and record a user's priority demand Internet service and bill the user accordingly.

2. Description of the Related Art

Computer systems in general and International Business Machines (IBM) compatible personal computer systems in particular have attained widespread use for providing computer power to many segments of today's modern society. Systems with microprocessors are finding themselves in an array of smaller and more specialized objects that previously were largely untouched by computer technology. Computer systems typically include a system processor and associated volatile and non-volatile memory, a display area, input means, and often interfaces, such as a network interface or modem, to other computing devices.

One of the distinguishing characteristics of these systems is the use of a system board to electrically connect these components together. These computing devices are information handling systems which are designed primarily to give independent computing power to a single user, or a group of users in the case of networked computing devices. Personal computing devices are often inexpensively priced for purchase by individuals or businesses. Nonvolatile storage devices such as hard disks, CD-ROM drives and magneto-optical drives are considered to be peripheral devices. Computing devices are often linked to one another using a network, such as a local area network (LAN), wide area network (WAN), or other type of network, such as the Internet. By linking to other computer systems, a computing device can use resources owned by another computing device. These resources can include files stored on nonvolatile storage devices and resources such as printers.

Servers perform different services for client computer systems. Web servers often provide content, or information, to client computers. Content provided by servers varies widely and includes such things as simple textual information (such as news articles and stock quotes), multimedia information (such as sound and graphics), software that is either downloaded to the client computer or executed to some extent on the server computer, and even real-time audio and video (such as that used in video conferencing). In order to run efficiently, some content needs to be provided to the user in a timely basis (such as a video conferencing application), while other content, such as text articles, is not compromised if the information is not provided on an expedited basis.

In order to accommodate users′ needs, a differentiated services Internet is being developed to prioritize packets of information that need to be delivered to the user on a faster basis. Packets include a header portion that determines, among other things, the destination of the packet (i.e., a server or client computer address). In a differentiated services Internet, the packets further include prioritization information detailing whether the packet is a high or low priority packet. High priority packets, such as those containing real-time teleconferencing information, are handled differently than lower priority packets. As the packets travel through the Internet from one computer to another, they pass through other computers including specialized devices called routers. Routers and other points along the Internet can be programmed to treat high priority packets differently in such a way that those packets travel through the Internet faster than their lower priority counterparts.

Users, often referred to as clients, generally connect to the Internet using an Internet Service Provider (ISP). While some plans bill the user a connection fee for the amount of time the user is connected to the Internet, most plans generally provide for flat based pricing whereby the user has either unlimited connection or a given amount of connect time for a flat periodic (i.e., monthly) charge. In addition, more users are using broadband services, such as cable modem connections, digital subscriber line (DSL) connections, and integrated services digital network (ISDN) connections. Besides offering faster transmission speeds than found with traditional modems, these connections often provide a constant connection between the user's computer and the Internet whenever the user's computer is turned on. In addition, while broadband connections provide for faster transmission speeds between the user's ISP and the user's computer, they do not effect the prioritization or treatment of the user's packets once they have been transferred from the ISP to various routers on their way to the server.

A challenge, therefore, exists with users use of differentiated services on the Internet. Users with high priority requirements, such as video conferencing, need a way to switch between high and normal priorities. A further challenge is charging high priority users a premium for their increased and preferential usage of Internet resources.

In addition, pricing for differentiated services may change. Users may be reluctant to purchase priority service without knowing beforehand what they will be charged for using the service. Another challenge, therefore, exists in informing users of the current priority pricing before the user establishes a priority service connection.

What is needed, therefore, is a way to provide users with a way to switch between high and normal prioritized usage of the Internet coupled with an effective billing system to bill users for their high priority usage. Furthermore, what is needed is a way to inform the user of the current priority pricing in aiding the user as to whether the priority service should be purchased.

### SUMMARY

It has been discovered that a user can request high priority treatment which causes packets sent to and from the user to be marked, or flagged, as high priority packets. The amount of time the user is operating as a high priority user is recorded so that the user can be billed accordingly. When the user no longer wishes to operate in a high priority mode, he can turn off the service upgrade request at which time the user's packets are marked as normal priority packets to which flat rate or normal billing rates apply. At the end of a billing cycle, the user's Internet Service Provider (ISP) calculates the amount of time the user spent as a high priority user and determines a price by combining the normal (or flat) rate changes with the high priority charges incurred by the user.

When computer systems or routers receive high priority packets destined to or from the user, the packets are handled in a manner to allow the packets to pass more quickly through the Internet on their way to or from the user. For example, devices such as routers include queues containing the packets currently being transmitted through the router. During busy traffic periods, the router may become full necessitating the router to drop certain packets. Packets marked as high priority packets, however, are not dropped thus increasing high priority packet throughput with respect to normal priority packets. In addition, routers can be programmed to process high priority packets before normal priority packets, even though the high priority packet may arrive at the router after the normal priority packet.

It has further been discovered that a priority pricing daemon can be used to inform the user of current priority pricing and receive the user's acceptance of such pricing before establishing the priority service. A network pricing daemon is interrupted or otherwise invoked when a user requests priority network service. The pricing daemon receives the current priority pricing from the network service provider and displays the price to the user. The user then has the choice of either accepting the current prioritized network pricing and receiving prioritized service or refusing the current prioritized network pricing and maintaining a normal level of service and pricing.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a system diagram showing a computer system using high and normal priorities;

FIG. 2 is a block diagram of a packet traveling between a client computer system and a server computer system through various routers;

FIG. 3 is a flowchart of service upgrade and billing processes for handling high priority packets;

FIG. 4 is a flowchart for router processing;

FIG. 5 is a block diagram of a client computer system using a pricing daemon to notify the user of the current service upgrade price;

FIG. 6a is a window interface for a user accepting or rejecting a service upgrade;

FIG. 6b is a flowchart for daemon processing for accepting or rejecting service upgrade pricing; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

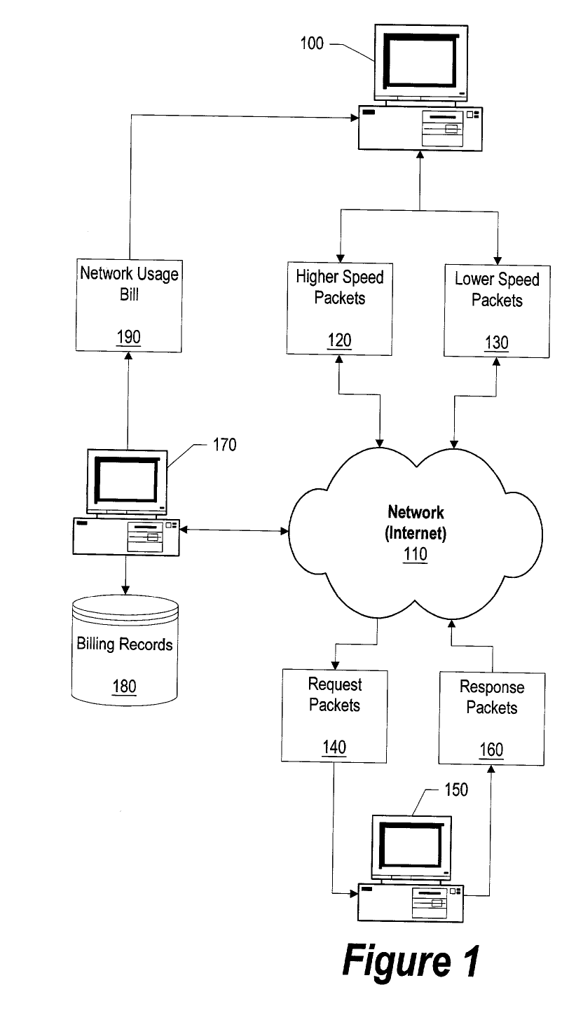

FIG. 1 shows a system diagram of a computer system using high and normal priorities. Client computer system 100 is connected to computer network 110, such as the Internet. Client computer system 100 can be connected to computer network 110 in a variety of ways. For example, client computer system 100 can use a modem to dial into an Internet Service Provider (ISP) that allows client computer system 100 access to computer network 110. Client computer system 100 could also use a cable modem connection, a DSL connection, a satellite connection, or an ISDN connection to access computer network 110. The user of client computer system 100 can choose to use higher speed service or lower speed service. When the user chooses to use higher speed service, then higher speed packets 120 are sent to and from client computer system 100. During normal operations, when the user does not need higher speed service, lower speed packets 130 are sent to and from client computer system 100. The priority of the packets is determined by analyzing the header area included with the packets. Among other things, the header area determines the destination of the packet and the priority assigned to the packet. Both higher speed packets 120 and lower speed packets 130 travel across computer network 110 to a destination computer system, such as server computer system 150. Server computer system 150 receives request packets 140 from various client computer systems, including client computer system 100, processes the requests, and returns response packets 160 to the client computer systems that made the corresponding requests. When a request packet includes a higher priority header, the server includes the higher priority header information in the corresponding response packet. In this manner, the higher priority packets both arrive at the destination computers in a prioritized fashion and are returned to the requesting client computer in a prioritized fashion. The return trip back to the client computer is often more important for prioritized processing because the client computer is often requesting large data files or data streams, such as those including multimedia content. These larger files benefit from prioritized processing in that larger files generally take longer to transmit over the Internet, especially during peak usage periods. However, with prioritized processing, the user is able to receive the content within a needed timeframe. To keep track of the user's prioritized processing, billing computer system 170 monitors the traffic to and from client computer system 100. In order to monitor the traffic, billing computer system 170 may be incorporated within the client's ISP. Packets traveling to and from the client computer system pass through the ISP on their way to or from the Internet. Billing computer system 170 analyzes the packet headers to determine which client computer is sending or receiving the packets. When prioritized header information is included in the packets, billing computer system 170 records the client's use of prioritized service in billing records data store 180. Various billing plans can be established for use of prioritized service. For example, users could purchase a certain amount of prioritized service per month as part of their regular Internet service bill, with additional prioritized service being charged on a per-minute basis. At the end of a billing cycle, billing computer 170 reads the recorded billing records 180 and prepares a network usage bill 190 for each of the ISP's customers.

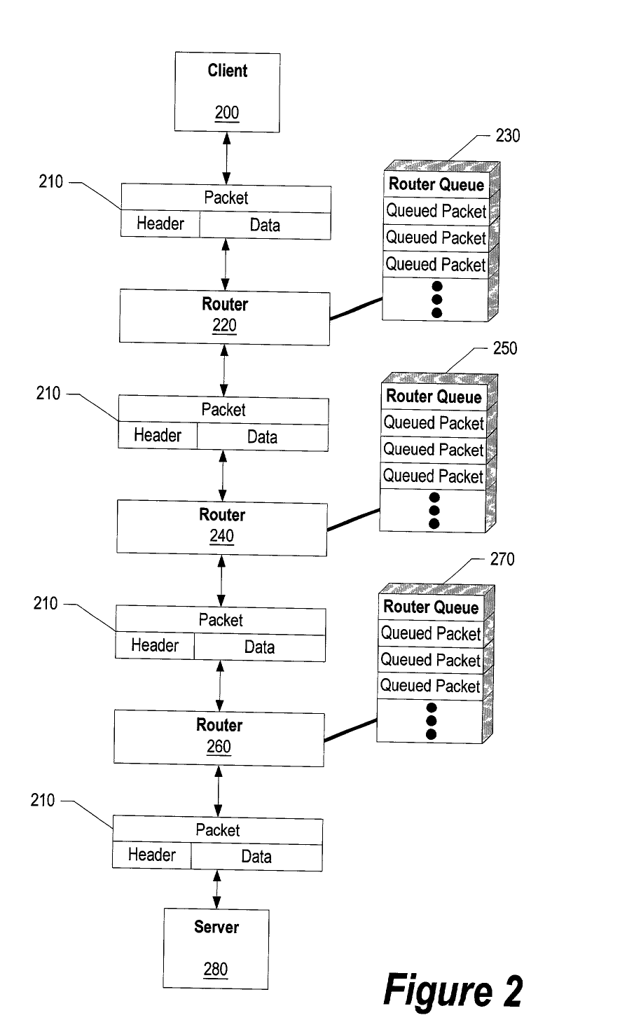

FIG. 2 shows a block diagram of a packet traveling between a client computer system and a server computer system through various routers. In the example shown, three routers (router 220, router 240, and router 260) are used to route packet 210 between client computer system 200 and server computer system 280. Packet 210 includes a header area and a data area. The header area indicates the source and destination addresses for the packet and any prioritization information. The data area of packet 210 includes the content being transmitted between the client and the server. The content may be a request (i.e., from the client to the server) or a response to a request (i.e., from the server to the client). Each router includes a queue identifying packets that have been received and that are waiting to be forwarded in order to reach their ultimate destination. Router 220 includes queue 230, router 240 includes queue 250, and router 260 includes queue 270. At each of the routers, packet 210 is added to the corresponding router queue. Each router includes a queue handling routine to process items in its queue. To provide prioritized service, the queue handling routine in each router reads the header portion of each packet to identify high priority packets. If a high priority packet is identified, logic within the queue handling routine is invoked to provide priority service to the identified packet. One priority service that the queue handling routine can provide regards packet dropping. When a queue becomes too busy and the memory allocated for the router's queue becomes full, some packets need to be dropped from the queue. When a packet is dropped, either client 200 or server 280 determines that a packet is missing and requests the other device to retransmit the missing packet. Consequently, retransmission of packets causes an increased in the overall transmission time needed to transmit the packet. The queue manager routine can avoid dropping high priority packets and, instead, drop lower priority packets waiting on the queue. Another way the queue manager routine can increase the throughput of high priority packets is by reordering the queue to put high priority packets toward the top of the queue. One type of reordering routine uses the amount of time a packet has waited on the queue and the packet's priority to determine a queue order. Those packets who have waited longer and those packets with higher priorities are thus moved toward the top of the queue, while packets that have newly entered the queue and packets with lower priorities are moved towards the end of the queue.

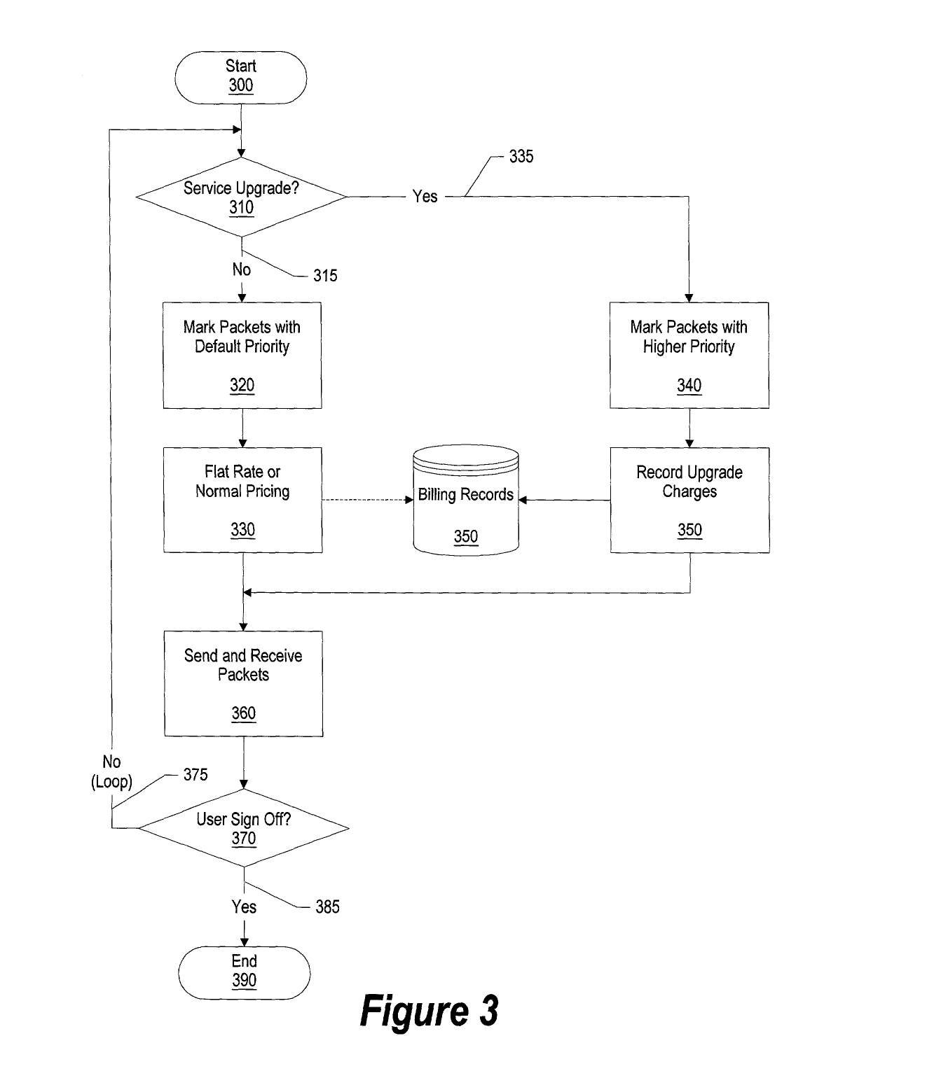

FIG. 3 shows a flowchart for service upgrading and billing processes for handling high priority packets. The processing could be part of an ISP's handling of client requests. In this way, the user would send a message to the ISP requesting a service upgrade in order to improve throughput to and from the client's computer system.

Processing commences at 300 whereupon a determination is made as to whether the user has requested a service upgrade (decision 310). If the user has not requested a service upgrade, “no” branch 315 is taken. During normal processing, packets are marked with a default priority setting (step 320) and the user is billed at the normal or flat rate (step 330) for handling packets. If the normal billing involves an hourly or per-minute rate, the customer's billing records are updated to track the amount of time that the customer spent using the network.

On the other hand, if the customer requested a service upgrade, decision 310 branches to “yes” branch 335. During a service upgrade, the header area of the customer's packets are marked to reflect the higher priority setting (step 340). The customer's use of the service upgrade is recorded in the customer's billing records (step 350). The higher priority packet marking and service upgrade charges continue until the customer requests that the service upgrade period be stopped or when the user signs off.

In either case, after the packets are marked and the appropriate information is captured in the billing records, the customer sends request packets and receives responsive packets from servers or other content providers (step 360). A determination is made as to whether the user has signed off (decision 370). If the user has not signed off, “no” branch 375 is taken looping back to decision 310 to check whether the user is requesting a service upgrade. This looping continues until the user requests to sign off, at which time “yes” branch 385 is taken and processing ends at 390.

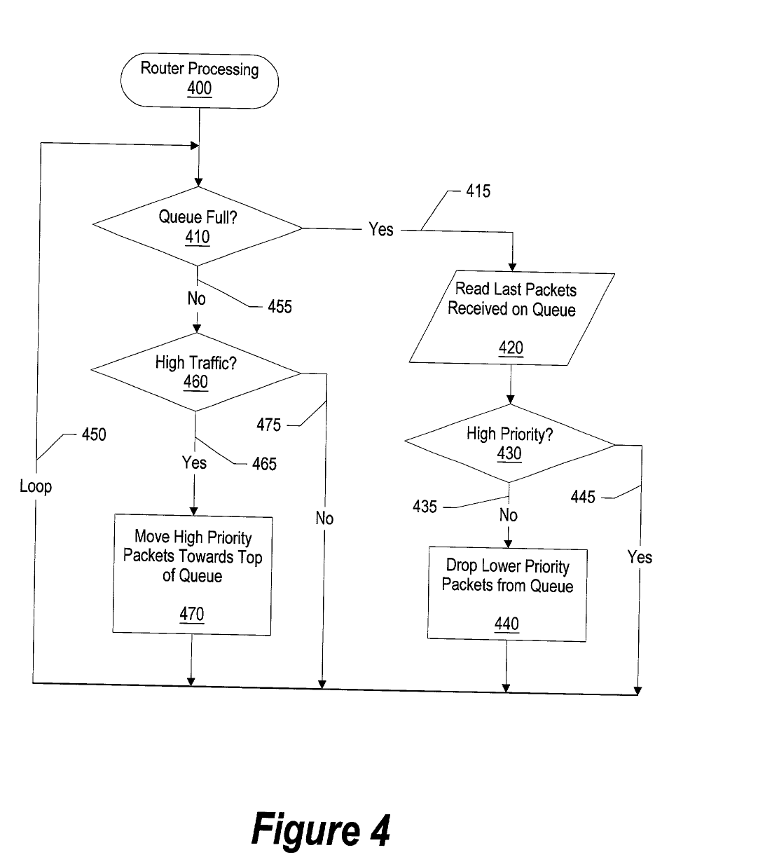

FIG. 4 shows a flowchart for router processing of high priority packets across the Internet. The router processing shown could be incorporated in the router's queue manager routine (discussed in FIG. 2) for handling packets queued at the router.

Processing commences at 400 whereupon a determination is made as to whether the memory allocated for the router's queue is full (decision 410). If the router's queue is full, decision 410 branches to “yes” branch 415 wherein the packets at the end of the queue are read (input 420). A determination is made as to whether each packet is a high priority packet (decision 430). If the packet is not a high priority packet, then “no” branch 435 is taken whereupon the low priority packets are dropped from the queue (step 440) and the memory associated with the dropped packets is freed for more queue entries. On the other hand, if packets read from the queue are high priority packets, then “yes” branch is taken preventing the high priority packets from being dropped from the queue. Processing loops back to the beginning (loop 450) to continue managing the router's queue.

If the memory allocated for the router's queue is not full, decision 410 branches to “no” branch 455 whereupon a determination is made as to the amount of congestion, or traffic, within the router (decision 460). If traffic is high, it may make sense to organize the queue in such a fashion to provide greater throughput for high priority packets. In such a case, “yes” branch 465 is taken and the queue is reorganized in order to move high priority packets toward the top of the queue (step 470). If the determination is made that the traffic within the router is not excessive or reorganizing the queue would probably not provide greater throughput to high priority packets, then “no” branch 475 is taken bypassing the queue reorganization step. In some embodiments, the queue may be continually organized to provide a weighted preference to high priority packets in order to provide greater throughput to such packets. In such a case, decision 460 could be eliminated and incoming packets automatically inserted in the queue based upon their priority. The queue could be continually organized based upon packets′ priority and the amount of time the packets have waited on the queue. In any event, processing continues by returning (loop 450) back to the beginning of the router processing in order to continue managing the router's queue.

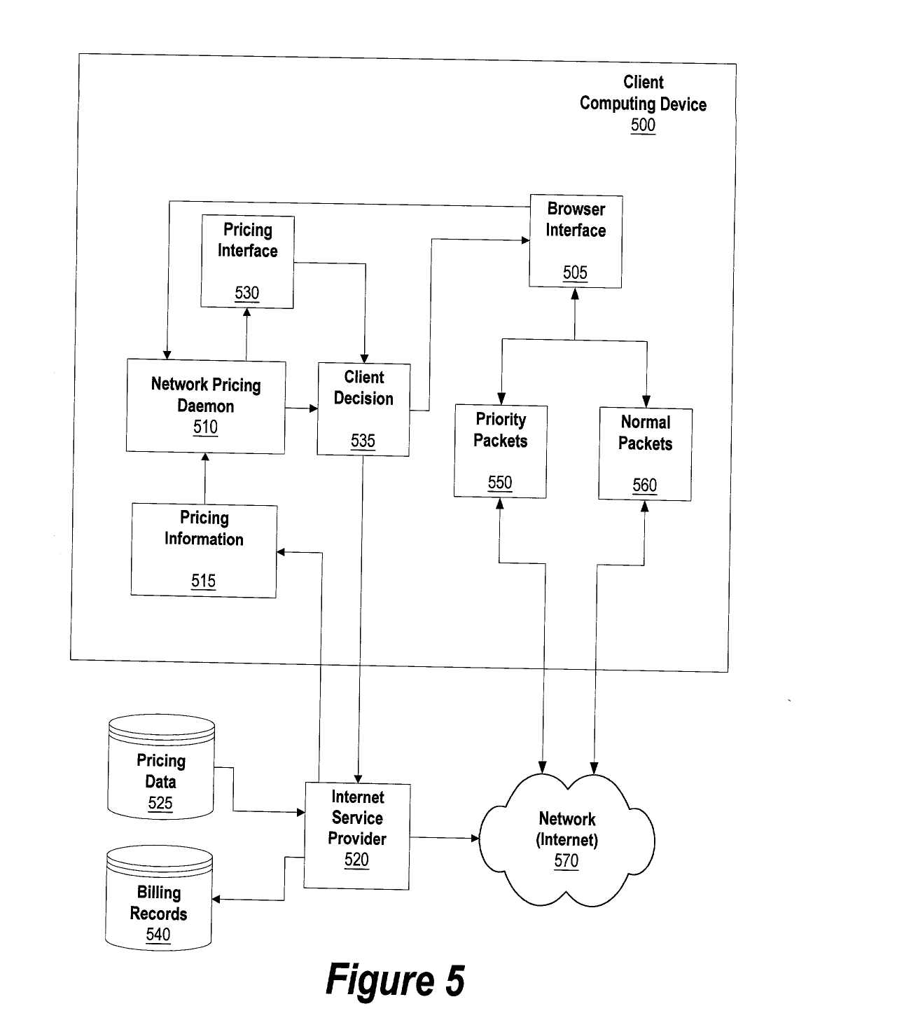

FIG. 5 shows a block diagram of a client computer system using a pricing daemon to notify the user of the current service upgrade price. Client computing device 500 may be a stand alone PC, a handheld device, or any device capable of connecting to a computer network, such as the Internet. Client computing device 500 includes browser interface 505 for communicating with the computer network. When the user wishes to perform a service upgrade, network pricing daemon 510 intercepts the request. Network pricing daemon 510 receives pricing information 515 which is received from a network service provider, such as Internet Service Provider 520. Pricing data 525 is maintained by Internet Service Provider 520 so that the prices for service may be altered as needed. Network pricing daemon 510 uses the received pricing information to display pricing interface 530 to the user. Based on the pricing information provided, the user decides whether to request the service upgrade in light of the service charge that will be applied. Client decision 535 is forwarded to Internet Service Provider 520. If the client wishes to perform the service upgrade, Internet Service Provider 520 keeps track of the user's upgrade charges in billing records 540. The client uses browser 505 to send and receive both priority packets 550 and normal packets 560. Packets addressed to or from client computing device 500 are marked as priority packets 550 for faster delivery through network 570. If the user does not wish to pay for upgraded service, packets addressed to or from client computing device 500 are marked as normal priority packets 560 for normal delivery through network 570 and billing records 540 are maintained accordingly.

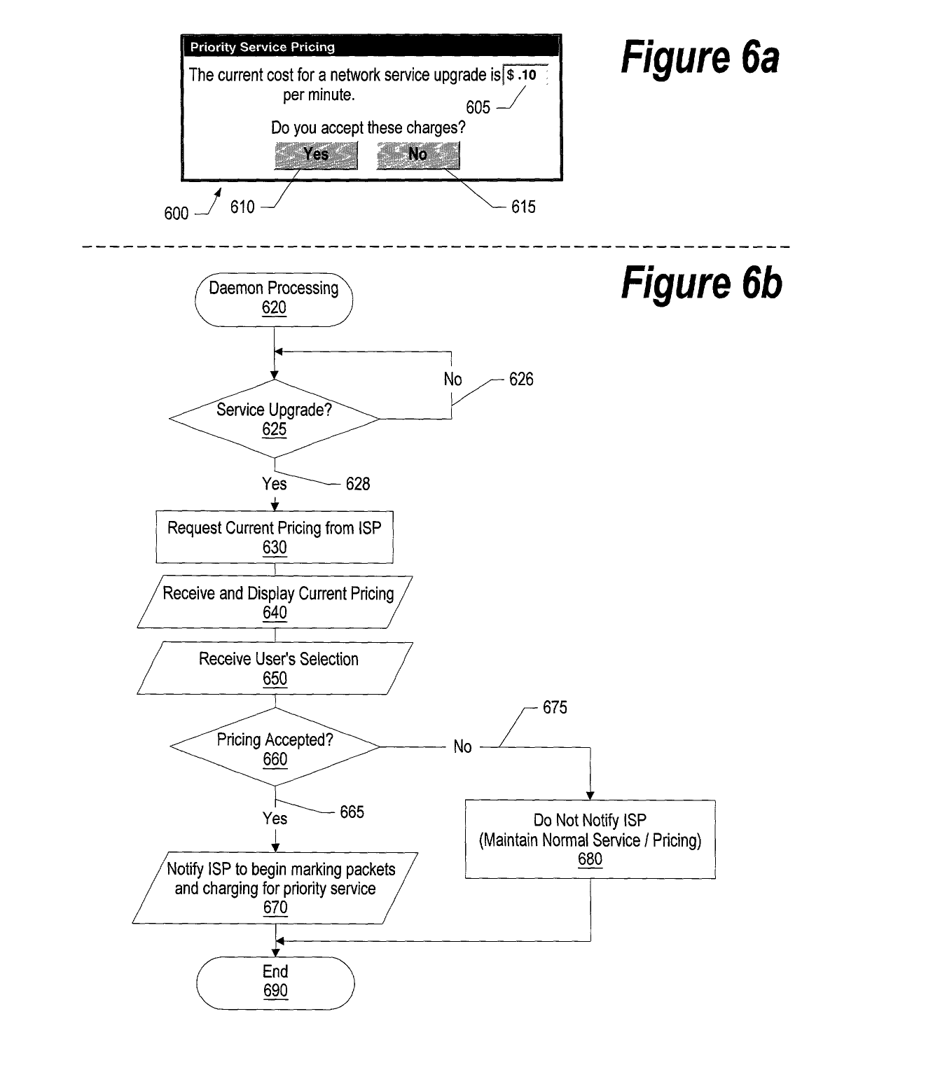

FIG. 6a shows a window interface for a user accepting or rejecting a service upgrade. Window 600 is displayed for the user when the user requests a priority service upgrade. Window 600 instructs the user to accept or reject the service upgrade based on the current pricing charged for the service upgrade. Current pricing 605 is received from the network provider, or Internet Service Provider, and displayed on window 600 for user action. The user selects “yes” command button 610 to accept the pricing for the service upgrade. If the user selects “no” command button 615, the user's service is not upgraded and the user is not charged for priority service.

FIG. 6b shows a flowchart for daemon processing for accepting or rejecting service upgrade pricing. Daemon processing begins at 620 whereupon a decision is made whether the user has requested a network service upgrade (decision 625). If the user has not requested a network service upgrade, “no” branch 626 is repeatedly taken looping back to the beginning of the processing until the user requests a network service upgrade. Daemon processing can also be programmed to wait for the user to request a service upgrade by using a semaphore or other type of interrupt to indicate that the user wishes to upgrade his or her network service. When the user requests to upgrade the network service, “yes” branch 628 is taken whereupon the current upgrade pricing is requested from the network service provider (step 630). This pricing information is received and an appropriate dialog window is displayed for the user including the current pricing information (output 640, see FIG. 6a for an example dialog box). The user's selection is received (input 650) based on the information provided to the user. If the pricing is accepted by the user, decision 660 branches to “yes” branch 665 whereupon the network service provider is notified (output 670) to begin marking the user's packets with priority headings and charging the user for priority service. On the other hand, if the pricing is not accepted by the user, decision 660 branches to “no” branch 675 whereupon the network service provider is not notified that the user wishes to upgrade service and normal pricing and service levels are maintained (step 680). Additionally, if the user was currently in an upgrade mode, step 680 would operate to reset the user's priority and pricing to normal levels with the network service provider. After the user's selection has been processed, daemon processing ends at 690. Note that daemon processing may be iterative to provide continuous monitoring of the user's service requests, however FIG. 6b illustrates the processing of one such service request.

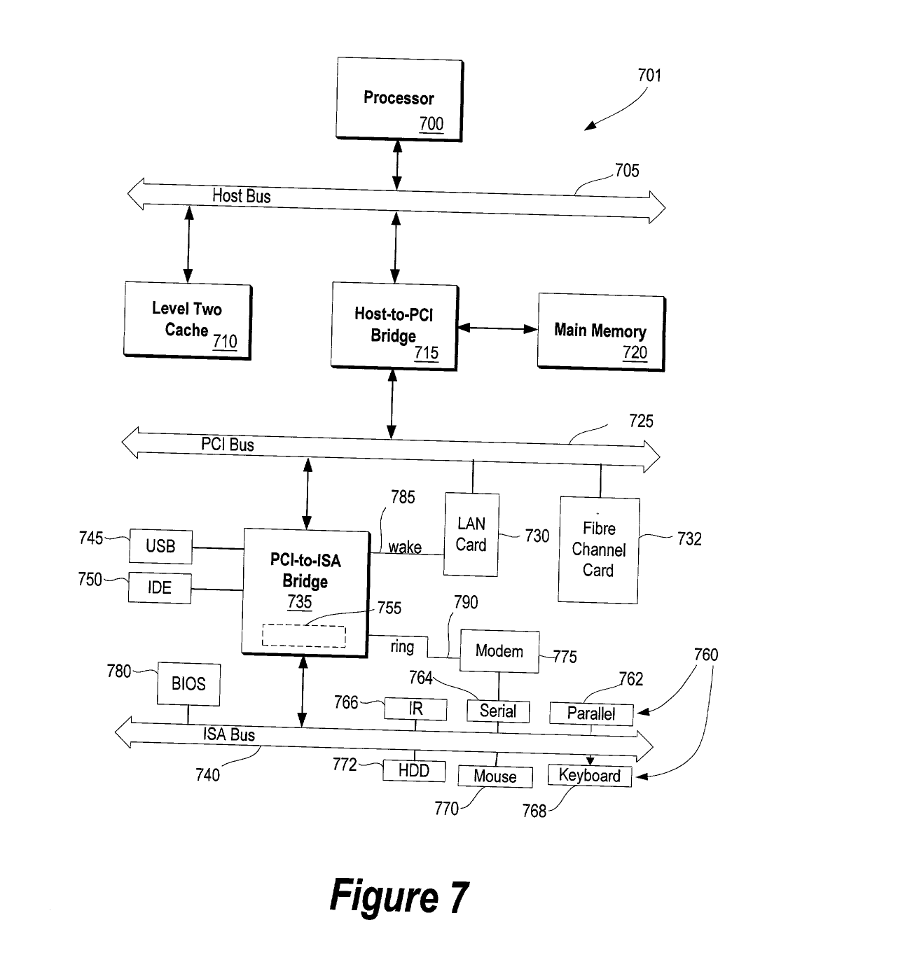

FIG. 7 illustrates information handling system 701 which is a simplified example of a computer system capable of performing the server and client operations described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a”0 or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of providing priority network service, said method comprising:
determining that a computer system has requested priority network service; and
identifying a usage amount in response to the determining.

2. The method as described in claim 1 further comprising:
storing the usage amount in a data store, wherein the usage amount includes an amount of time that the computer system used the priority network service.

3. The method as described in claim 2 further comprising:
reading the stored usage amount from the data store;
determining a billing amount from the stored usage amount;
preparing a billing statement in response to the determining; and
sending the billing statement to a customer.

4. The method as described in claim 1 further comprising:
receiving a priority network request message from the computer system;
receiving a second request message from the computer system; and
calculating an elapsed time between the receipt of the priority network request message and the receipt of the second request message.

5. The method as described in claim 1 further comprising:
writing a high priority header to one or more packets originating from the computer system in response to the determining.

6. The method as described in claim 1 further comprising:
writing a normal priority header to one or more packets originating from the computer system in response to determining that the computer system has not requested priority network service.

7. The method as described in claim 1 further comprising:
sending one or more packets received from the computer system to a second computer system connected to a computer network.

8. An information handling system comprising:
one or more processors;
a memory accessible by the processors;
a network interface connecting the information handling system to a computer network; and
a network priority tool to provide priority network service, the network priority tool including:
means for determining that a computer system has requested priority network service; and
means for identifying a usage amount in response to the determining.

9. The information handling system as described in claim 8 further comprising:
means for storing the usage amount in a data store, wherein the usage amount includes an amount of time that the computer system used the priority network service.

10. The information handling system as described in claim 9 further comprising:
means for reading the stored usage amount from the data store;
means for determining a billing amount from the stored usage amount;
means for preparing a billing statement in response to the determining; and
means for sending the billing statement to a customer.

11. The information handling system as described in claim 8 further comprising:
means for receiving a priority network request message from the computer system;
means for receiving a second request message from the computer system; and
means for calculating an elapsed time between the receipt of the priority network request message and the receipt of the second request message.

12. The information handling system as described in claim 8 further comprising:
means for writing a high priority header to one or more packets originating from the computer system in response to the determining.

13. The information handling system as described in claim 8 further comprising:
means for writing a normal priority header to one or more packets originating from the computer system in response to determining that the computer system has not requested priority network service.

14. The information handling system as described in claim 8 further comprising:
means for sending one or more packets received from the computer system to a second computer system connected to a computer network.

15. A computer program product for providing priority network service, said computer program product comprising:
means for determining that a computer system has requested priority network service; and
means for identifying a usage amount in response to the determining.

16. The computer program product as described in claim 15 further comprising:
means for storing the usage amount in a data store, wherein the usage amount includes an amount of time that the computer system used the priority network service.

17. The computer program product as described in claim 16 further comprising:
means for reading the stored usage amount from the data store;
means for determining a billing amount from the stored usage amount;
means for preparing a billing statement in response to the determining; and
means for sending the billing statement to a customer.

18. The computer program product as described in claim 15 further comprising:
means for receiving a priority network request message from the computer system;
means for receiving a second request message from the computer system; and
means for calculating an elapsed time between the receipt of the priority network request message and the receipt of the second request message.

19. The computer program product as described in claim 15 further comprising:
means for writing a high priority header to one or more packets originating from the computer system in response to the determining.

20. The computer program product as described in claim 15 further comprising:
means for sending one or more packets received from the computer system to a second computer system connected to a computer network.
